(19) United States
(12) Patent Application Publication
(10) Pub. No.: US 2012/0054086 A1
(43) Pub. Date: Mar. 1, 2012

(54) CARBON DIOXIDE MONITORING APPARATUS FOR VEHICLES, CARBON DIOXIDE MANAGEMENT SYSTEM, AND CARBON DIOXIDE MANAGEMENT METHOD USING SAME

(76) Inventor: Jung Hwang Choi, Gyeonggi-do (KR)

(21) Appl. No.: 13/319,302

(22) PCT Filed: Apr. 8, 2010
(86) PCT No.: PCT/KR2010/002147

§ 371 Date: Nov. 7, 2011

(30) Foreign Application Priority Data
May 7, 2009 (KR) 10-2009-0039790

(51) Int. Cl. G06F 7/00; G06Q 40/04

(52) U.S. Cl. 705/37; 701/1; 701/123

(57) ABSTRACT

The present invention relates to a carbon dioxide monitoring apparatus for vehicles, and to a carbon dioxide management system and carbon dioxide management method using same. It is an aim of the present invention to provide a carbon dioxide monitoring apparatus for vehicles, as well as a carbon dioxide management system and a carbon dioxide management method using same, which enable drivers and passengers to visually check the amount of carbon dioxide emitted by vehicles to alert the drivers and passengers to the emission of carbon dioxide, and which compensate vehicle owners for reducing the emission of carbon dioxide by maintaining a constant travel speed or the like, thereby correcting driving habits and reducing the emission of carbon dioxide, thus achieving environmentally-friendly fuel-saving effects. To accomplish the aim, the carbon dioxide monitoring apparatus for vehicles according to the present invention comprises: a microcomputer (110) in which identification numbers of vehicles are stored; detection means for detecting travel-related information from vehicles in accordance with the control of the microcomputer; arithmetic operation means for calculating the amount of CO₂ reduction by comparing the amount of CO₂ emitted, obtained from the travel-related information, to standard fuel efficiency; transmitting/receiving means for transmitting/receiving arithmetic operation information on the amount of CO₂ emitted through a wired or wireless system; an external output port (150) for outputting the arithmetic operation information on the amount of CO₂ emitted and travel-related information stored in the microcomputer (110) to the outside; and a display (160) for displaying the arithmetic operation information on the amount of CO₂ emitted on a real-time basis.

### TECHNICAL FIELD

The present invention disclosed herein relates to a carbon dioxide monitoring apparatus for vehicles, carbon dioxide management system, and carbon dioxide management method using the same, and more particularly, to an environmentally-friendly carbon dioxide monitoring apparatus for vehicles, a carbon dioxide management system, and a carbon dioxide management method using the same which enable a diver to visually check a CO₂ emission amount emitted according to vehicle driving states, thereby recognizing the need for fuel saving and also reducing the CO₂ emission amount.

### BACKGROUND ART

Recently, a lot of studies are being conducted on environmentally-friendly alternative energies because fossil fuels have been exhausted and have a bad influence on the environment. In various fields such as, for example, hybrid electric vehicles, fuel cells, hydrogen engines, and biodiesel engines, researches and developments are being conducted on alternative energies.

However, fossil fuels as represented by crude oil have been much used across all industries such as chemical industry, but are main factors causing environmental pollution. In particular, a lot of studies and legal regulations are being made in order to reduce the amount of carbon dioxide emission, which most greatly affects global warming.

When the fossil fuels are used as vehicle fuels, a large amount of carbon dioxide is emitted. In particular, for vehicles, the amount is getting larger due to bad driving habits such as rapid acceleration.

In recent years, there has been a global movement for restricting the amount of carbon dioxide emission from household appliances in addition to vehicles.

### DISCLOSURE

### Technical Problem

The present invention is designed considering these points. The present invention can enable a driver and passengers to visually check the amount of carbon dioxide emitted by a vehicle, thereby being alerted to carbon dioxide emission. And also, the present invention can compensate a vehicle owner for the amount of carbon dioxide emission which is reduced due to cruise drive, thereby correcting driving habits. Accordingly, the present invention provides an environmentally-friendly carbon dioxide monitoring apparatus for vehicles, a carbon dioxide management system, and a carbon dioxide management method using the same, which can save fuels.

### Technical Solution

A carbon dioxide monitoring apparatus includes: a microcomputer having an identification number of a vehicle; a detection unit detecting driving-related information from the vehicle under the control of the microcomputer; a calculation unit calculating a reduction amount through a CO₂ amount compared with standard fuel efficiency from the driving-related information; a transmission/reception unit transmitting/receiving calculation information about the CO₂ amount in a wired or wireless manner; an output port 150 outputting the driving-related information and the calculation information about the CO₂ amount stored in the microcomputer 110; and a display 160 displaying the driving-related information and the calculation information about the CO₂ amount to a driver in a real time.

The carbon dioxide monitoring apparatus may be equipped in a navigation device for vehicle

The driving-related information may include a driving distance, fuel consumption, standard fuel efficiency, and CO₂ amount/km.

The calculation unit may calculate a driving distance based on fuel consumption from a CO₂ emission amount according to a standard fuel efficiency to obtain reduction information about the CO₂ amount, the standard fuel efficiency having been previously input to the microcomputer 110.

The transmission/reception unit may be an RF-ID module.

In another embodiment, a CO₂ management system using a carbon dioxide monitoring apparatus for vehicles includes: a carbon dioxide monitoring apparatus installed in a vehicle; a plurality of mediation server receiving calculation information about a CO₂ amount in a wired or wireless manner; and a central server connected with the plurality of mediation server through a wired or wireless communication network and collecting, aggregating, and outputting the calculation information about a CO₂ amount for each vehicle.

The plurality of mediation servers may be installed in a counter at a tollgate, entrance at a parking lot, or gas pump at a gas station.

In further another embodiment, a CO₂ management system using a carbon dioxide monitoring apparatus for vehicle includes: a first step S100 of detecting driving-related information by using a carbon dioxide monitoring apparatus 100 equipped in a vehicle; a second step S200 of calculating a CO₂ reduction amount in a calculation unit 130 of the carbon dioxide monitoring apparatus 100; a third step S300 of transmitting the calculated CO₂ reduction amount and the driving-related information to a mediation server 200; a fourth step of aggregating the CO₂ reduction amount in a central server 300 on the basis of the CO₂ reduction amount and the driving-related information, the CO₂ reduction amount and the driving-related information being received from each mediation server 200, and determining whether the aggregated result is greater than a reference value or exceed a predetermined period; a fifth step S500 of notifying a vehicle owner to be a compensation subject due to CO₂ reduction through the carbon dioxide monitoring apparatus 100 in the central server 300 and enabling the vehicle owner to select a compensation method; and a sixth step of selling the CO₂ reduction amount when requested according to carbon dioxide emission.

The second step S200 may display the currently calculated CO₂ reduction amount and a CO₂ reduction amount reduced for a predetermined period in a real time.

The third step S300 may transmit the calculated CO₂ reduction amount and the driving-related information to the mediation server 200 using a transmission/reception unit 140 of the carbon dioxide monitoring apparatus 100 in a wired or wireless manner, or using an output port 150 of the carbon dioxide monitoring apparatus 100 or wired/wireless communication port. The fourth step S400 may perform the third step S300 if the aggregated calculated CO₂ reduction amount is less than a reference value or does not exceed a predetermined period.

The compensation method may include at least one of an oil coupon, parking ticket, e-money, cash, and gift certificate.

### Advantageous Effects

According to the present invention, the following effects can be attained.

1) A vehicle owner is compensated for the CO₂ reduction amount, which may be sold in the CO₂ market.

2) Since a driver can check fuel efficiency and carbon dioxide emission amount visually, the driver is alert to these, thus assisting fuel consumption savings and safety driving.

3) A synergy can be achieved between the sense of alarm and fuel savings.

4) The reduction of carbon dioxide emitted as an exhaust gas can be beneficial to the environment.

### DESCRIPTION OF DRAWINGS

FIG. 1 is a block diagram illustrating an entire configuration of a CO₂ monitoring apparatus according to the present invention;

FIG. 2 is a configuration diagram illustrating a configuration of a CO₂ management system according to the present invention; and

FIG. 3 is a flow chart illustrating a CO₂ management method according to the present invention.

### EMBODIMENTS OF THE INVENTION

Hereinafter, embodiments of the present invention will be described in detail with reference to the accompanying drawings.

(Configuration of CO₂ Monitoring Apparatus)

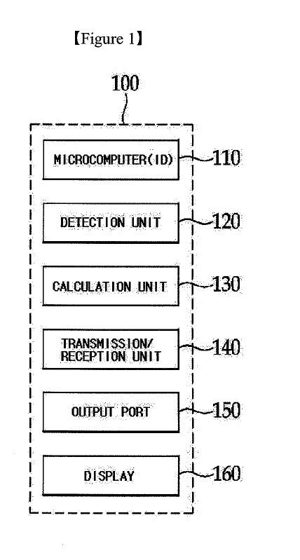

FIG. 1 is a block diagram illustrating an entire configuration of a carbon dioxide monitoring apparatus according to the present invention. Herein, a reference numeral “100” denotes a CO₂ monitoring apparatus as a carbon dioxide monitoring apparatus (abbreviation).

A CO₂ monitoring apparatus 100 includes a microcomputer 110 controlling the apparatus overall, a detection unit 120 detecting driving-related information needed for calculating a CO₂ reduction amount, a calculation unit 130 calculating the CO₂ reduction amount, a transmission/reception unit 140 transmitting/receiving data to/from the outside, an output port 150 outputting the data, and a display 160 displaying the calculation result and a vehicle driving state.

Hereinafter, embodiments of the present invention will be described in detail for every element.

The microcomputer 110 controls the CO₂ monitoring apparatus 100 according to the present invention overall and particularly includes an identification ID for identifying the CO₂ monitoring apparatus 100 equipped for each vehicle. The identification ID may be configured in a chip form inside the microcomputer 110, and may be configured with hardware which is a circuit equipped in the microcomputer 110 and with software which is identification number through a programming.

In particular, information required for calculating the CO₂ reduction amount may have been previously input in the microcomputer 110 and be output and used whenever required. This information includes a CO₂ emission amount (CO₂ amount/km) and fuel consumption or standard fuel efficiency which is publicly announced according to each car model. The driving-related information may not be directly input to the microcomputer 110 and may be obtained through a sensor (not shown) or electronic control device (not shown) controlling vehicles, using a detection unit 120 which will be described below.

The detection unit 120 functions as obtaining the driving-related information, which is needed to calculate the CO₂ reduction amount, from a vehicle. The detection unit 120 may be programmed in the microcomputer 110 or implemented with hardware such as a sensor.

Herein, the driving-related information includes a drive distance, fuel consumption, standard fuel efficiency, and hence CO₂ emission amount (CO₂ amount/km). As described in detail among the driving-related information, since the standard fuel efficiency or CO₂ emission amount (CO₂ amount/km) may have been previously input according to each car model, information stored in the microcomputer 110 may be used.

In particular, the detection unit 120 may further include a CO₂ detection sensor detecting carbon dioxide contained in an exhaust gas to directly detect the CO₂ emission amount, and may receive the CO₂ emission amount from a sensor which is typically equipped to be used in a smoke reduction.

The calculation unit 130 calculates the CO₂ reduction amount according to a driving distance of a vehicle. Then, the calculation is made using the described-above driving-related information under the control of the microcomputer 110. That is, the calculation unit 130 calculates the CO₂ reduction amount on the basis of the CO₂ emission amount per unit distance (CO₂ amount/km) and standard fuel efficiency provided when a vehicle came out of the factory.

For example, in a case of a 2,000 cc gasoline engine, the CO₂ emission amount is 220 g/km, and thus if the driving distance is about 2000 km a year, the CO₂ emission amount for a year is 4,400 kg/20,000 km theoretically. However, the actual CO₂ emission amount detected through the detection unit 120 may be more or less than the theoretical CO₂ emission amount (4,400 kg/20,000 km). The calculation unit 130 calculates the CO₂ reduction amount with the difference and stores the calculated result in the microcomputer 110.

The transmission/reception unit 140 transmits the CO₂ reduction amount calculated in the calculation unit 130 to an outside. Then, the transmission/reception unit 140 also transmits vehicle information, for example, information on the identification ID of a vehicle under the control of the microcomputer 110.

The transmission/reception unit 140 may be manufactured in a module form which can make wired or wireless transmission. In the exemplary embodiment of the present invention, an RF-ID module is advantageous to short-distance transmission and capable of a contact or contactless communication.

Also, the transmission/reception unit 140 functions as receiving a control signal for initialization of the CO₂ monitoring apparatus 100 or for remote reset of information on the CO₂ reduction amount.

The output port 150 has the same function as the transmission/reception unit 140, and also may be used to output the information on the CO₂ reduction amount stored in the microcomputer 110 to an outside using a wired device such as a USB. As described above, the output port 150 may have a function of receiving a control signal.

In addition, the output port 150 may be connected to hardware, for example, an external storage memory to output the required data or to directly receive the control signal.

The display 160 displays the CO2 reduction amount and current driving state of a vehicle to a driver and passengers in a real time, using an LCD or LED. Accordingly, a driver or passenger is alerted to environmental issues such as energy saving in addition to CO₂ emitted by a vehicle.

In an exemplary embodiment of the present invention, the CO₂ monitoring apparatus 100 as described above may be manufactured as a separate element and equipped in a vehicle, and may be implemented in software or hardware in a navigation which is recently equipped in a vehicle.

(CO₂ Management System)

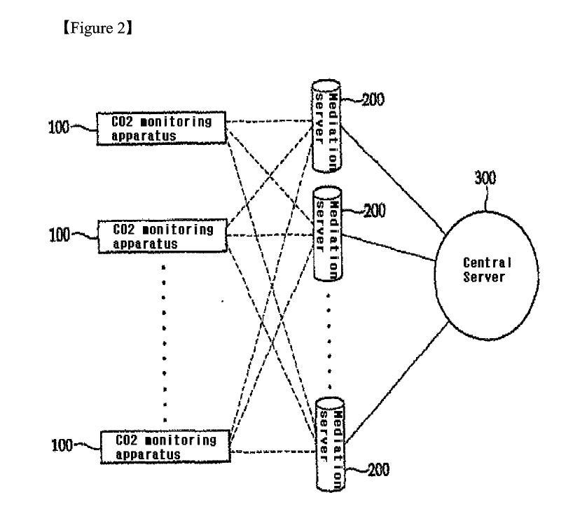

FIG. 2 is a view illustrating a configuration of a CO₂ management system according to the present invention. Herein, a reference numeral “100” denotes a CO₂ monitoring apparatus according to the present invention, as described above.

The CO₂ management system includes a CO₂ monitoring apparatus 100 equipped in each vehicle according to the present invention, a plurality of mediation servers 200 receiving CO₂ reduction information and vehicle information when a vehicle is moved and parked, and a central server 300 aggregating and outputting the CO₂ reduction information and vehicle information for each vehicle, which are transmitted from each of the mediation servers. Herein, since the CO₂ monitoring apparatus 100 is described above, its detailed description will be omitted.

The mediation servers 200 are installed where a lot of vehicles gather together to receive the vehicle information and CO₂ reduction information from each vehicle in a wired or wireless manner and transmit the information to the central server 300.

Whatever includes a transmission/reception unit communicating with the transmission/reception unit 140 which may identify an RF-ID signal may be used as the mediation server 200. For example, a typical server, personal computer, and personal server may be used.

The mediation servers 200 may be configured to receive relevant data through the transmission/reception unit 140 automatically although the mediation servers 200 are not installed where a lot of vehicles gather together, for example, a counter at a tollgate, entrance at a parking lot, or gas pump at a gas station, and a driver of a vehicle does not transmit data separately. It also may be configured in a way that a driver may transmit relevant data.

As illustrated in FIG. 2, the plurality of mediation servers 200 receive relevant information from the CO₂ monitoring apparatus 100 which is installed in each vehicle, and transmit the information to the central server 200. At this point, the central server 300 receives the relevant information, considering a time period after receiving the relevant information.

The central server 300 is connected to the mediation server 200 through a wired or wireless communication network. In particular, the central server 300 collects the vehicle information and CO₂ reduction information which are received from the mediation servers 200 for each vehicle and outputs the collected information.

The output can be seen by a driver, such as the total amount of CO₂ reduction which is received by now through the mediation servers 200, using the CO₂ monitoring apparatus 100. And also, the output may have various forms such as the total amount of CO₂ reduction for each quarter.

In an exemplary embodiment of the present invention, the central server 300 may compensate a vehicle owner for the CO₂ reduction amount and sell the CO₂ reduction amount. This will be described later in detail in a CO₂ management method.

(Management Method)

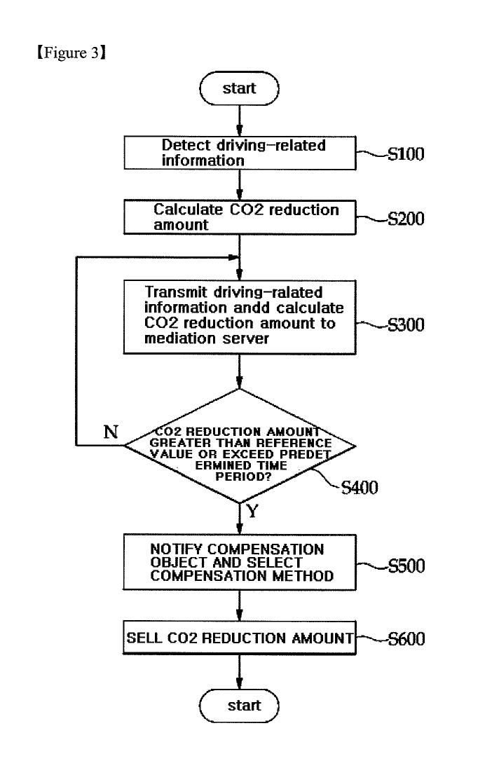

FIG. 3 is a flow chart illustrating a CO₂ management method according to the present invention.

A CO₂ management method according to the present invention includes six following steps.

Hereinafter, this will be described in detail for every step.

In the first step S100, driving-related information is detected. The driving-related information is detected by the detection unit 120 of the CO₂ monitoring apparatus 100. At this point, the detected information at least includes a CO₂ amount/km based on the standard fuel efficiency and identification number, driving distance, and CO₂ detection amount generated through an actual exhaust gas.

In the second step S200, a CO₂ reduction amount is calculated. A CO₂ reduction amount is calculated through the difference between an actual CO₂ emission amount detected in a vehicle by the detection unit 120 and a theoretical CO₂ emission amount calculated multiplying a CO₂ amount/km based on the fuel efficiency by a driving distance.

The calculated CO₂ reduction amount as well as the detected CO₂ emission amount is displayed on the display in a real time, thereby being altered to energy savings.

In the third step S300, the CO₂ reduction amount and driving-related information are transmitted to the mediation server 200. The transmitting of a CO₂ reduction amount and driving-related information may be performed using a wired or wireless communication network by the transmission/reception unit 140, using the output port 150 to be directly connected to mediation server 200, or using hardware such as a USB or external memory.

In the fourth step S400, the CO₂ reduction amount for each vehicle is collected and it is determined whether the collected result is greater than a reference value or has exceeded a predetermined time period. This is made in the central server 300.

The central server 300 sets a reference value suitable for each point of the collected CO₂ reduction amount and determines whether the collected CO₂ reduction amount is greater or less than the reference value in order to collect the CO₂ reduction amount in a point method and notify the collected result to a driver. Alternatively, the central server 300 collects a CO₂ reduction amount for a predetermined time period, for example, one month and one quarter and then notifies the collected result to a driver.

The determination is for giving convenience in compensating a driver for a CO₂ reduction amount in the fifth step S500. Other kinds of CO₂ reduction amount measuring method may be allowed.

In the fourth step S400, if a CO₂ reduction amount is less than a reference value or do not exceed the predetermined period, the central server 300 may perform the third step S300 to return a standby state in which relevant information can be received from corresponding vehicles in order to satisfy the determination standard.

In the fifth step S500, the corresponding content is notified to an owner of a vehicle being a compensation subject, and a compensation method is selected. This is controlled to be visually displayed through the display 160 of the CO₂ monitoring apparatus 100 using a control signal in the central server 300.

That is, the central server 300 notifies a driver to a use state of the CO₂ reduction amount collected primarily. In this case, the central server 300 provides various compensation methods as the use state of the CO₂ reduction amount.

For example, to compensate for the collected CO₂ reduction amount, mileages or points may be provided. Alternatively, one of an oil coupon, parking ticket, e-money, cash, and gift certificate may be provided.

In the sixth step S600, the CO₂ reduction amount is sold when requested. The CO₂ reduction amount is sold when requested by a company needing more CO₂ reduction or CO₂ emission.

In this case, the request for the sale of CO₂ emission amount is made to the central server 300 through a typical wired or wireless communication network. The central server 300 deals with the request by requesting the sale amount and price payment method through a wired or wireless communication network to a sale requester.

Accordingly, the present invention can display data about the CO₂ emission amount emitted by a vehicle to a driver, thereby being alerted to environmental pollution and energy over-consumption. And also, a vehicle owner can be compensated for the CO₂ reduction amount, thereby saving energy and reducing exhaust gas.

While the inventive invention has been particularly shown and described with reference to exemplary embodiments thereof, it will be understood that various changes in form and details may be made therein without departing from the spirit and scope of the following claims. Accordingly, appended claims will include various variations or modifications within subject matters of the present invention.

### INDUSTRIAL APPLICABILITY

The present invention relates to an environmentally-friendly carbon dioxide monitoring apparatus for vehicles, a carbon dioxide management system, and a carbon dioxide management method using the same which enable a diver to visually check a CO₂ emission amount emitted according to a vehicle driving state, thereby recognizing the need for fuel saving and also reducing the CO₂ emission amount.

1. A carbon dioxide monitoring apparatus for vehicle comprising:
a microcomputer having an identification number of the vehicle;
a detection unit detecting driving-related information from the vehicle under the control of the microcomputer;
a calculation unit calculating a reduction amount through a CO₂ amount compared with standard fuel efficiency from the driving-related information;
a transmission/reception unit transmitting/receiving calculation information about the CO₂ amount in a wired or wireless manner;
an output port outputting the driving-related information and the calculation information about the CO₂ amount stored in the microcomputer; and
a display displaying the driving-related information and the calculation information about the CO₂ amount to a driver in a real time.

2. The carbon dioxide monitoring apparatus of claim 1, wherein the carbon dioxide monitoring apparatus is equipped in a navigation device for vehicle.

3. The carbon dioxide monitoring apparatus of claim 1, wherein the driving-related information comprises a driving distance, fuel consumption, standard fuel efficiency, and CO₂ amount/km.

4. The carbon dioxide monitoring apparatus of claim 1, wherein the calculation unit calculates a driving distance based on a fuel consumption from a CO₂ emission amount according to a standard fuel efficiency to obtain reduction information about the CO₂ amount, the standard fuel efficiency having been previously input to the microcomputer.

5. The carbon dioxide monitoring apparatus of claim 1, wherein the transmission/reception unit is an RF-ID module.

6. A CO₂ management system using a carbon dioxide monitoring apparatus for vehicle comprising:
a carbon dioxide monitoring apparatus of claim 1 installed in a vehicle;
a plurality of mediation server receiving calculation information about a CO₂ amount in a wired or wireless manner; and
a central server connected with the plurality of mediation server through a wired or wireless communication network and collecting, aggregating, and outputting the calculation information about a CO₂ amount for each vehicle.

7. The CO₂ management system of claim 6, wherein the plurality of mediation servers are installed in a counter at a tollgate, entrance at a parking lot, or gas pump at a gas station.

8. A CO₂ management method using a carbon dioxide monitoring apparatus for vehicle comprising:
a first step of detecting driving-related information by using a carbon dioxide monitoring apparatus equipped in a vehicle;
a second step of calculating a CO₂ reduction amount in a calculation unit of the carbon dioxide monitoring apparatus;
a third step of transmitting the calculated CO₂ reduction amount and the driving-related information to a mediation server;
a fourth step of aggregating the CO₂ reduction amount in a central server on the basis of the CO₂ reduction amount and the driving-related information which are received from each mediation server and determining whether the aggregated result is greater than a reference value or exceed a predetermined period;
a fifth step of notifying a vehicle owner to be a compensation subject due to CO₂ reduction through the carbon dioxide monitoring apparatus in the central server and enabling the vehicle owner to select a compensation method, when the aggregated result is greater than a reference value or exceed a predetermined period; and
a sixth step of selling the CO₂ reduction amount when requested according to carbon dioxide emission.

9. The CO₂ management method of claim 8, wherein the second step displays the currently calculated CO₂ reduction amount and a CO₂ reduction amount reduced for a predetermined period in a real time.

10. The CO₂ management method of claim 8, wherein the third step transmits the calculated CO₂ reduction amount and the driving-related information to the mediation server using a transmission/reception unit of the carbon dioxide monitoring apparatus in a wired or wireless manner, or copying by using an output port of the carbon dioxide monitoring apparatus or wired/wireless communication port.

11. The CO₂ management method of claim 8, wherein the fourth step performs the third step if the aggregated calculated CO₂ reduction amount is less than a reference value and does not exceed a predetermined period.

12. The CO₂ management method of claim 8, wherein the compensation method comprises at least one of an oil coupon, parking ticket, e-money, cash, and gift certificate.
